(19) United States
(12) Patent Application Publication
(10) Pub. No.: US 2026/0349443 A1
(43) Pub. Date: Nov. 5, 2026

(54) AUTONOMOUS MOBILE DEVICE AND METHOD FOR CONTROLLING THE SAME, AND COMPUTER READABLE STORAGE MEDIUM

(71) Applicant: WILLAND (BEIJING) TECHNOLOGY CO., LTD., Beijing (CN)

(72) Inventors: Shaoguang ZHANG, Beijing (CN); Degan LIN, Beijing (CN)

(21) Appl. No.: 19/111,845

(22) PCT Filed: Oct. 16, 2023
(86) PCT No.: PCT/CN2023/124806

§ 371 Date: Mar. 14, 2025

(30) Foreign Application Priority Data
Dec. 22, 2022 (CN) 202211654444.8

(51) Int. Cl. G05D 1/661; A01D 34/00; A01D 101/00; G05D 1/24; G05D 1/622; G05D 1/644; G05D 107/20; G05D 109/10

(52) U.S. Cl. CPC G05D 1/661; A01D 34/008; G05D 1/24; G05D 1/622; G05D 1/644; A01D 2101/00; G05D 2107/23; G05D 2109/10

(57) ABSTRACT

The present disclosure provides an autonomous mobile device, a method for controlling the autonomous mobile device and a computer readable storage medium. The method includes: determining a first working area where an entrance of a first passage is located when the autonomous mobile device detects that there is an obstacle in the first passage during a process of moving to a charging pile along the first passage; determining a target passage among a plurality of second passages connected with the first working area, where each of the second passages is a passage that the autonomous mobile device has not passed during a pile returning process; controlling the autonomous mobile device to travel along the target passage so that the autonomous mobile device moves to the charging pile. In the present disclosure, during the process that the autonomous mobile device moves to the charging pile along the first passage, if the first passage is impassable, the passage is replaced, so that the autonomous mobile device can move to the charging pile along a replaced passage, and the problem that the autonomous mobile device cannot return to the charging pile is avoided.

### CROSS-REFERENCE TO RELATED APPLICATION

The present application claims priority to Chinese Patent Application No. 202211654444.8, titled “AUTONOMOUS MOBILE DEVICE AND METHOD FOR CONTROLLING THE SAME, AND COMPUTER READABLE STORAGE MEDIUM”, filed to China National Intellectual Property Administration on Dec. 22, 2022, which is hereby incorporated by reference in its entirety.

### TECHNICAL FIELD

The present disclosure relates to a technical field of autonomous mobile devices and, in particular, to an autonomous mobile device, a method for controlling the autonomous mobile device and a computer readable storage medium.

### BACKGROUND

With the improvement of people's living standards, autonomous mobile devices such as lawn mowers, sweepers and robots have become indispensable electrical appliances in our lives.

The autonomous mobile device would return to a charging pile when power is insufficient or after a work task is finished. The charging pile is connected with a working area through a passage, and the autonomous mobile device needs to pass through the passage to return to the charging pile from the working area.

In the exemplary technology, there may be temporary static obstacles in the passage of the work area, for example, vehicles are temporarily parked in the passage, or there may be dynamic obstacles such as people or animals in the passage. In a process of the autonomous mobile device returning to the charging pile, if there are obstacles in the passage, the autonomous mobile device would not pass through the passage, making it impossible for the autonomous mobile device to return to the charging pile.

### SUMMARY

The present disclosure provides an autonomous mobile device, a method for controlling the autonomous mobile device and a computer readable storage medium, which are used for solving a problem that the autonomous mobile device cannot return to a charging pile.

In a first aspect, the present disclosure provides a method for controlling an autonomous mobile device, including:
determining a first working area where an entrance of a first passage is located when the autonomous mobile device detects that there is an obstacle in the first passage during a process of moving to a charging pile along the first passage;
determining a target passage among a plurality of second passages connected with the first working area, where each of the second passages is a passage that the autonomous mobile device has not passed during a pile returning process; and
controlling the autonomous mobile device to travel along the target passage so that the autonomous mobile device moves to the charging pile.

In an embodiment, where the step of determining a target passage among a plurality of second passages connected with the first working area includes:
determining a pile returning path corresponding to each of the second passages according to a position of the autonomous mobile device, a position of the second passage and a position of the charging pile;
determining the target passage among the second passages according to each pile returning path.

In an embodiment, the step of determining the target passage among the second passages according to each pile returning path includes:
determining a second passage corresponding to a pile returning path whose path length is shorter than a preset path length as the target passage.

In an embodiment, where the autonomous mobile device is a mowing robot, and the step of determining a second passage corresponding to a pile returning path whose path length is shorter than a preset path length as the target passage includes:
when pile returning paths whose path lengths are shorter than the preset path length share a same path length, determining a degree of mowing completion of a working area which is passed by the pile returning paths with the same path length; and
determining a second passage in a pile returning path corresponding to a maximum degree of mowing completion as the target passage.

In an embodiment, the step of determining the target passage among the second passages according to each pile returning path includes:
acquiring remaining power of the autonomous mobile device;
determining, based on a length of the pile returning path and a power consumption per unit length, a total power consumption for returning to the charging pile according to the pile returning path by the autonomous mobile device;
determining a second passage included in a pile returning path corresponding to a total power consumption less than the remaining power as the target passage.

In an embodiment, the step of determining a pile returning path corresponding to each of the second passages according to a position of the autonomous mobile device, a position of the second passage and a position of the charging pile includes:
determining a second working area connected with the first working area according to the second passage;
determining a position of a third passage in the second working area, where the third passage is connected with an area where the charging pile is located and the second working area;
determining the pile returning path corresponding to the second passage according to the position of the autonomous mobile device, the position of the second passage, the position of the charging pile and the position of the third passage.

In an embodiment, the step of determining a target passage among a plurality of second passages connected with the first working area includes:
determining a distance for the autonomous mobile device to travel to each of the second passages;
determining a second passage corresponding to a minimum distance as the target passage.

In an embodiment, the step of determining a target passage among a plurality of second passages connected with the first working area includes:
acquiring historical path information about the autonomous mobile device returning to the charging pile;
determining a first number of times that the autonomous mobile device passes through the second passage and a second number of times that the second passage is impassable according to the historical path information;
determining a probability value that the second passage is impassable according to the first number of times and the second number of times; and
determining a second passage corresponding to a probability value smaller than a preset threshold as the target passage.

In an embodiment, the step of determining a second passage corresponding to a probability value smaller than a preset threshold as the target passage includes:
when a plurality of probability values smaller than the preset threshold are the same, determining a smallest first number of times among first numbers of times for second passages corresponding to the plurality of probability values;
determining a second passage corresponding to the smallest first number of times as the target passage.

In a second aspect, the present disclosure further provides an autonomous mobile device, including:
a determining module, configured to determine a first working area where an entrance of a first passage is located when the autonomous mobile device detects that there is an obstacle in the first passage during a process of moving to a charging pile along the first passage;
the determining module is configured to determine a target passage among a plurality of second passages connected with the first working area, where each of the second passages is a passage that the autonomous mobile device has not passed during a pile returning process;
a controlling module, configured to control the autonomous mobile device to travel along the target passage so that the autonomous mobile device moves to the charging pile.

In a third aspect, the present disclosure further provides an autonomous mobile device, including: a memory and a processor;
the memory store computer executable instructions;
the processor executes the computer executable instructions stored in the memory, so that the autonomous mobile device executes the method for controlling the autonomous mobile device according to each embodiment of the foregoing first aspect.

In a fourth aspect, the present disclosure further provides a computer readable storage medium, where the computer readable storage medium stores computer executable instructions, and when the computer executable instructions are executed by a processor, the method for controlling the autonomous mobile device according to each embodiment of the foregoing first aspect is implemented.

In a fifth aspect, the present disclosure further provides a computer program product, the computer program product includes computer program instructions that cause a computer to execute the method for controlling the autonomous mobile device according to each embodiment of the foregoing first aspect.

In a sixth aspect, the present disclosure further provides a computer program, the computer program, when running on a computer, causes the computer to execute the method for controlling the autonomous mobile device according to each embodiment of the foregoing first aspect.

According to the autonomous mobile device, the method for controlling the autonomous mobile device and the computer readable storage medium provided by the present disclosure, the autonomous mobile device determines a working area where an entrance of a first passage is located when the autonomous mobile device detects that there is an obstacle in the first passage during a process of moving to a charging pile along the first passage; and determines a target passage among a plurality of second passages connected with the working area, so as to control the autonomous mobile device to move to the charging pile along the target passage. In the present disclosure, during the process that the autonomous mobile device moves to the charging pile along the first passage, if the first passage is impassable, the passage is replaced, so that the autonomous mobile device can move to the charging pile along a replaced passage, and the problem that the autonomous mobile device cannot return to the charging pile is avoided.

### BRIEF DESCRIPTION OF DRAWINGS

The accompanying drawings, which are incorporated in and constitute a part of this description, illustrate embodiments consistent with the present disclosure and together with the description, serve to explain the principles of the present disclosure.

FIG. 1 is a schematic diagram of a scenario related to a method for controlling an autonomous mobile device according to the present disclosure.

FIG. 2 is a flowchart of a first embodiment of a method for controlling an autonomous mobile device according to the present disclosure.

FIG. 3 is a schematic diagram of another scenario related to a method for controlling an autonomous mobile device according to the present disclosure.

FIG. 4 is a flowchart of a second embodiment of a method for controlling an autonomous mobile device according to the present disclosure.

FIG. 5 is a schematic diagram of another scenario related to a method for controlling an autonomous mobile device according to the present disclosure;

FIG. 6 is a flowchart of a third embodiment of a method for controlling an autonomous mobile device according to the present disclosure.

FIG. 7 is a flowchart of a fourth embodiment of a method for controlling an autonomous mobile device according to the present disclosure.

FIG. 8 is a schematic diagram of functional modules of an autonomous mobile device according to the present disclosure.

FIG. 9 is a schematic diagram of a hardware structure of an autonomous mobile device according to the present disclosure.

Through the above drawings, specific embodiments of the present disclosure have been shown, as will be described in more detail below. These drawings and written descriptions are not intended to limit the scope of the concepts of the present disclosure in any way, but to explain the concepts of the present disclosure to those skilled in the art by referring to specific embodiments.

### DESCRIPTION OF EMBODIMENTS

Reference will now be made in detail to exemplary embodiments, examples of which are illustrated in the accompanying drawings. When the following description refers to the drawings, unless otherwise indicated, the same numbers in different drawings indicate the same or similar elements. The embodiments described in the following exemplary embodiments do not represent all embodiments consistent with the present disclosure. Rather, they are merely examples of devices and methods consistent with some aspects of the present disclosure as detailed in the appended claims.

An autonomous mobile device would return to a charging pile when the power is insufficient or a work task is finished. The charging pile is connected with a working area through a passage, and the autonomous mobile device needs to pass through the passage to return to the charging pile from the working area.

The inventor of the present disclosure has found that there may be temporary static obstacles in the passage of the work area, for example, vehicles may be temporarily parked in the passage, or there may be dynamic obstacles such as people or animals in the passage. In the process of the autonomous mobile device returning to the charging pile, if there are obstacles in the passage, the autonomous mobile device would not pass through the passage, making it impossible for the autonomous mobile device to return to the charging pile.

Therefore, the inventors of the present disclosure thought that in the process of the autonomous mobile device moving to the charging pile along a first passage, if the first passage is impassable, the passage should be replaced, so that the autonomous mobile device can move to the charging pile along a replaced passage, so as to avoid a situation where the autonomous mobile device cannot return to the pile.

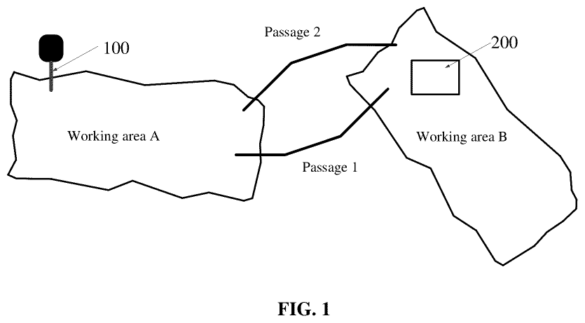

Referring to FIG. 1, FIG. 1 is a schematic diagram of a scenario related to a method for controlling an autonomous mobile device according to the present disclosure. As shown in FIG. 1, a charging pile 100 is located in a working area A, and an autonomous mobile device 200 is located in a working area B. A plurality of passages are arranged between the working area A and the working area B. For example, the working area A and the working area B are provided with a passage 1 and a passage 2. The autonomous mobile device 200 can return from the working area B to the charging pile 100 along the passage 1. If an obstacle is detected in the passage 1, the autonomous mobile device 200 returns from the working area B to the charging pile along the passage 2. It should be noted that the two passages set in the work areas are only for illustration purpose, which does not limit the number of passages set in the work areas.

In the following, the technical scheme of the present disclosure and how the above technical problem can be solved by the technical scheme of the present disclosure will be explained in detail with specific examples. The following specific embodiments can be combined with each other, and the same or similar concepts or processes may not be repeated in some embodiments. Embodiments of the present disclosure will be described below with reference to the accompanying drawings.

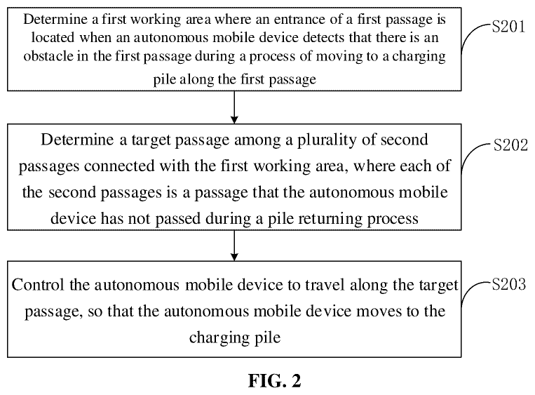

Referring to FIG. 2, which is a first embodiment of a method for controlling an autonomous mobile device according to the present disclosure, and the method for controlling the autonomous mobile device includes the following steps:
Step S201: determine a first working area where an entrance of a first passage is located when the autonomous mobile device detects that there is an obstacle in the first passage during a process of moving to a charging pile along the first passage.

In this embodiment, the autonomous mobile device can be a movable device such as a sweeper, a lawn mower or a robot. The autonomous mobile device will return to the charging pile after finishing a work task or power of the autonomous mobile device is insufficient. When the autonomous mobile device returns to the charging pile, the autonomous mobile device will obtain a working area where it is located through positioning. The working area is provided with a plurality of passages, which are used to connect one working area with another, and the autonomous mobile device can move from one working area to another through the passages.

The autonomous mobile device will move across the map during a mapping stage to create a map, and the map includes multiple working areas and passages set in each working area.

After obtaining the working area where it is located through positioning, the autonomous mobile device determines passages in the working areas from the map, so as to select one passage from the passages and return to the charging pile. The passage currently selected by the autonomous mobile device is defined as a first passage.

The autonomous mobile device detects whether there is an obstacle in the first passage in real time through its own radar during a process of moving to the charging pile along the first passage. If an obstacle is detected in the first passage, the first passage is impassable, that is, the obstacle blocks the moving of the autonomous mobile device, and the autonomous mobile device needs to change the passage to return to the charging pile. In this regard, the autonomous mobile device determines the working area where the entrance of the first passage is located, which is defined as the first working area. It should be noted that the first passage has two exits, and an exit through which the autonomous mobile device enters the first passage is determined as the entrance of the first passage.

Step S202, determine a target passage among a plurality of second passages connected with the first working area, where each of the second passages is a passage that the autonomous mobile device has not passed during a pile returning process.

The autonomous mobile device will record the first passage when it detects that the first passage is impassable. The first working area is connected with a plurality of passages, and the autonomous mobile device removes the first passage from the plurality of passages based on the recorded first passage to obtain a plurality of second passages, that is, the autonomous mobile device removes the impassable passage(s) from the plurality of passages. As the autonomous mobile device can only detect whether a passage is passable when it moves to the passage, and the impassable passage(s) is(are) removed, therefore, the second passage is a passage that the autonomous mobile device has not passed in the pile returning process, that is, the second passage is a passage that the autonomous mobile device has not traveled in the pile returning process.

The autonomous mobile device determines the target passage in the second passages. Illustratively, the autonomous mobile device may select a second passage as the target passage randomly.

Step S203, control the autonomous mobile device to travel along the target passage, so that the autonomous mobile device moves to the charging pile.

After determining the target passage, the autonomous mobile device retreats from the first passage to the entrance of the first passage, and then moves from the entrance of the first passage to the entrance of the target passage to enter the target passage, so as to move along the target passage and make the autonomous mobile device move to the charging pile.

In the embodiment, when the autonomous mobile device moves to the charging pile along the first passage, if the first passage is impassable, the passage is replaced, so that the autonomous mobile device can move to the charging pile along a replaced passage, so as to avoid a situation that the autonomous mobile device cannot return to the charging pile.

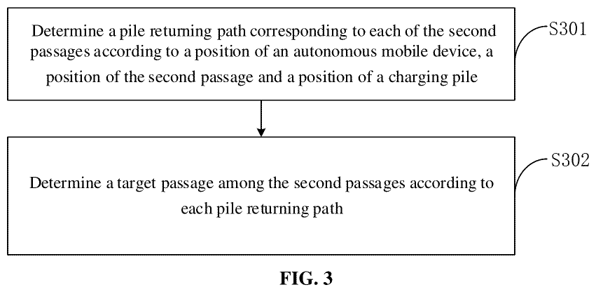

Referring to FIG. 3, which is a second embodiment of a method for controlling an autonomous mobile device according to the present disclosure. Based on the first embodiment, step S202 includes:
Step S301, determine a pile returning path corresponding to each of the second passages according to a position of the autonomous mobile device, a position of the second passage and a position of the charging pile.

In this embodiment, after determining the second passages, the autonomous mobile device plans pile returning paths including the second passages, and the autonomous mobile device can return to the charging pile along the pile returning paths. There are a plurality of second passages, and a second passage corresponds to at least one pile returning path, that is, there are a plurality of pile returning paths. The autonomous mobile device determines the pile returning path for each of the second passages through its own position, the position of the second passage and the position of the charging pile.

In an example, the autonomous mobile device determines, based on its own location, a first path for the autonomous mobile device to retreat to the entrance of the first passage; plans, based on the position of the entrance of the second passage, a second path for the autonomous mobile device to travel from the entrance of the first passage to the entrance of the second passage; plans, based on a position of the exit of the second passage and the position of the charging pile, a third path for the autonomous mobile device to travel; splices the first path, the second path, the second passage and the third path to obtain the pile returning path corresponding to the second passage.

In another example, the second passage set for the first working area is connected to a second working area which is not the working area where the charging pile is located. The second working area is provided with a passage connecting the working area where the charging pile is located, and the passage is defined as a third passage, that is, the third passage connects the working area where the charging pile is located and the second working area. The autonomous mobile device determines a second working area connected with the first working area based on the second passage, and then determines a position of the third passage for the second working area. After determining the third passage for the second working area, the autonomous mobile device determines the pile returning path corresponding to the second passage according to the position of the autonomous mobile device, the position of the second passage, the position of the charging pile and the position of the third passage. Specifically, the autonomous mobile device determines a first path for the autonomous mobile device to retreat to the entrance of the first passage based on its own position; plans a second path for the autonomous mobile device to travel from the entrance of the first passage to the entrance of the second passage based on the position of the entrance of the second passage; plans a fourth path based on a position of the exit of the second passage and a position of the entrance of the third passage, and plans a fifth path for the autonomous mobile device to travel based on a position of the exit of the third passage and the position of the charging pile. The first path, the second path, the second passage, the fourth path, the third passage and the fifth path are spliced to obtain the pile returning path corresponding to the second passage.

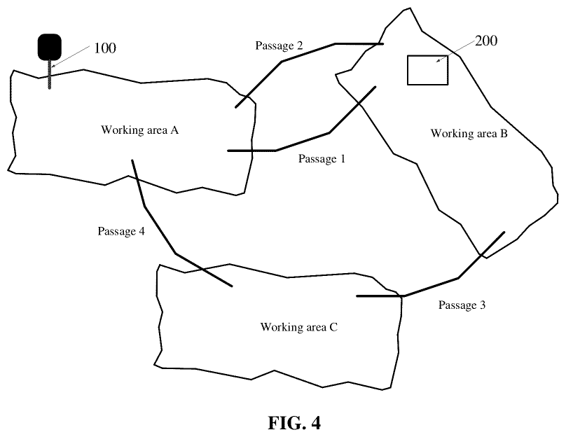

Referring to FIG. 4, the map includes a working area A, a working area B and a working area C. An autonomous mobile device 200 is located in the working area B, a charging pile 100 is located in the working area A, a passage 1 and a passage 2 are set between the working area B and the working area A, a passage 3 is set between the working area B and the working area C, and a passage 4 is set between the working area C and the working area A. If the second passage is the passage 3, the third passage is then the passage 4, that is, the pile returning path corresponding to the second passage includes the passage 3 and the passage 4.

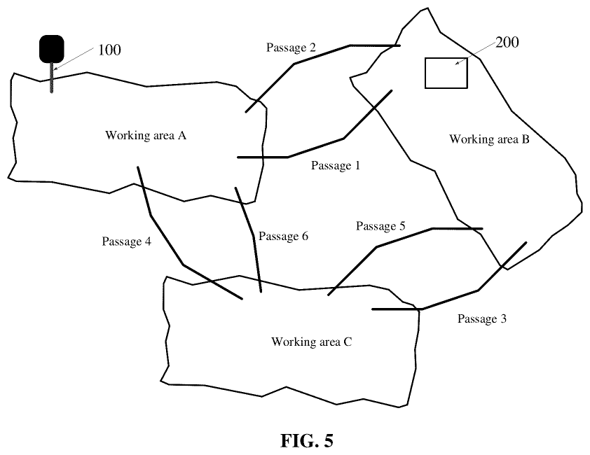

It should be noted that a plurality of second passages can be set between the first working area and the second working area, and a plurality of third passages can also be set between the second working area and the area where the charging pile is located, so that the second passage can correspond to a plurality of pile returning paths. For example, referring to FIG. 5, a passage 3 and a passage 5 are set between the work area B and the work area C, and a passage 5 and a passage 6 are set between the work area C and the work area A, then there are two corresponding pile returning paths for the passage 5 as the second passage, where one pile returning path includes the passage 5 and the passage 4, and the other pile returning path includes the passage 5 and the passage 6. Similarly, there are two corresponding pile returning paths for the passage 3 as the second passage, where one pile returning path includes the passage 3 and the passage 4, and the other pile returning path includes the passage 3 and the passage 6.

Step S302, determine a target passage among the second passages according to each pile returning path.

The autonomous mobile device determines the target passage among the second passages based on respective pile returning paths.

In an example, the autonomous mobile device calculates a path length of each pile returning path, and determines the second passage corresponding to a pile returning path whose path length is shorter than a preset path length as the target passage. Preferably, determine a minimum path length among respective path lengths which are shorter than the preset path length, and the second passage in the pile returning path with the minimum path length is the target passage. The autonomous mobile device chooses a short path to return to the charging pile, which reduces the pile returning time of the autonomous mobile device and improves the pile returning efficiency of the autonomous mobile device. Further, the autonomous mobile device is a mowing robot, and when pile returning paths whose path lengths are shorter than the preset path length share the same path length, determine the degree of mowing completion of the working area passed by the pile returning paths with the same path length. For example, the pile returning paths with the same path length are pile returning paths 1, which pass a working area 1 and a working area 2. The degree of mowing completion of the two working areas is determined based on mowing progresses of the working area 1 and the working area 2 recorded by the autonomous mobile device. For example, the mowing progress of the working area 1 is 50% and the mowing progress of the working area 2 is 40%, then the degree of mowing completion of the two working areas is =(50%+40%)/2=45%. The greater the degree of mowing completion, the less the grass passed through by the autonomous mobile device in the pile returning process, and the smaller the resistance endured by the autonomous mobile device during the pile returning process, so the less the power consumption and the shorter the pile returning time. Therefore, a second passage in the pile returning path corresponding to the maximum degree of mowing completion is determined as the target passage.

In another example, the autonomous mobile device needs to return to the charging pile for charging due to insufficient power. Therefore, in the process of pile returning, remaining power of the autonomous mobile device needs to support itself to return to the charging pile. In this regard, the autonomous mobile device acquires its own remaining power, and determines, based on a length of the pile returning path and a power consumption per unit length, a total power consumption for returning to the charging pile according to the pile returning path by the autonomous mobile device. The power consumption per unit length refers to the power consumed by the autonomous mobile device when moving a unit length at a set moving speed. The autonomous mobile device determines a second passage included in the pile returning path corresponding to the total power consumption less than the remaining power as the target passage. For example, the length of the pile returning path is 200 m, and the power consumption per unit length is 50 m/%. 50 m/% means that the autonomous mobile device loses one percent of power each time it moves 50 m at the set moving speed, so the total power consumption=200 m/(50 m/%)=4%, and the remaining power of the autonomous mobile device is 5%, so the second passage included in the pile returning path can be used as the target passage.

In the embodiment, the autonomous mobile device determines the pile returning path corresponding to the second passage, thereby determining the target passage in each of the second passages based on each pile returning path, so that the autonomous mobile device returns to the charging pile along the target passage.

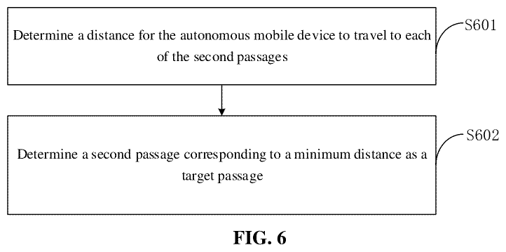

Referring to FIG. 6, FIG. 6 is a third embodiment of a method for controlling an autonomous mobile device according to the present disclosure, and based on the first embodiment, step S202 includes:
Step S601, determine a distance for the autonomous mobile device to travel to each of the second passages;
Step S602, determine a second passage corresponding to a minimum distance as the target passage.

In the embodiment, after determining the second passages, the autonomous mobile device plans a moving path based on the location where the autonomous mobile device is located and the location of the entrance of the second passage, that is, the moving path is a path that the autonomous mobile device moves from the current location to the location of the entrance of the second passage.

The autonomous mobile device calculates a length of each moving path, so as to obtain distances for the autonomous mobile device to move to the second passages. Determine the minimum distance among the distances, and determine the second passage corresponding to the minimum distance as the target passage.

In this embodiment, the autonomous mobile device selects the second passage closest to the autonomous mobile device as the target passage according to a proximity principle, so as to return to the charging pile along the target passage.

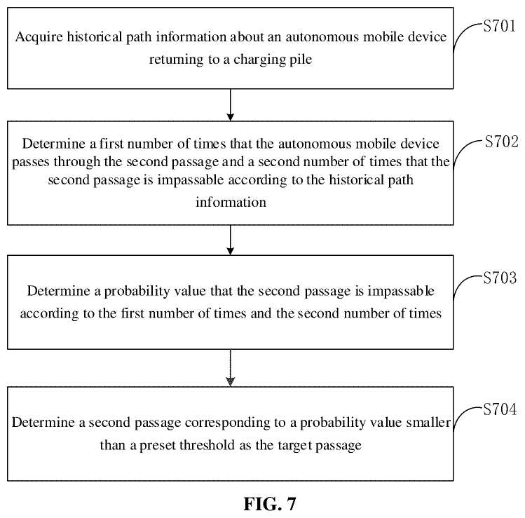

Referring to FIG. 7, FIG. 7 is a fourth embodiment of a method for controlling an autonomous mobile device according to the present disclosure. Based on the first embodiment, step S202 includes:
Step S701: acquire historical path information about the autonomous mobile device returning to the charging pile.

In this embodiment, after detecting that the first passage is impassable, the autonomous mobile device needs to predict an unblocked passage based on historical information, so as to return to the charging pile successfully.

In this regard, the autonomous mobile device acquires the historical path information about the autonomous mobile device returning to the charging pile. The historical path information includes a retraced path of the autonomous mobile device, the retraced path is a path that the autonomous mobile device retreats to the entrance of the passage after detecting the passage with an obstacle.

Step S702, determine a first number of times that the autonomous mobile device passes through the second passage and a second number of times that the second passage is impassable according to the historical path information.

Based on the historical path information, the autonomous mobile device counts, for each of the second passages, the second number of times that the second passage is impassable and the first number of times that the autonomous mobile device passes through the second passage. For example, if the retraced path includes the second passage, the second number of times for the second passage plus 1, that is, the autonomous mobile device counts the number of times for which it retraces in the second passage to obtain the second number of times.

Step S703, determine a probability value that the second passage is impassable according to the first number of times and the second number of times.

Step S704, determine a second passage corresponding to a probability value smaller than a preset threshold as the target passage.

The autonomous mobile device divides the second number of times for the second passage by the first number of times for the second passage, thus obtaining a probability value that the autonomous mobile device cannot pass through the second passage. A preset threshold is stored in the autonomous mobile device. After obtaining the probability values corresponding to respective second passages, the autonomous mobile device determines the probability value(s) which is(are) smaller than the preset threshold, and a probability that the autonomous mobile device passes through the second passage corresponding to the probability value smaller than the preset threshold is higher, so such second passage can be used as the target passage. Of course, the second passage corresponding to a minimum probability value can also be regarded as the target passage.

Further, when a plurality of probability values smaller than the preset threshold are the same, determine a smallest first number of times among first numbers of times for second passages corresponding to the plurality of probability values, and determine a second passage corresponding to the smallest first number of times as the target passage. Understandably, among the second passages with the same probability value, the second passage with the least pass-through times of the autonomous mobile devices is determined, and the second passage with the smallest number of pass-through times is the target passage. By selecting the second passage with the smallest number of pass-through times as the target passage, the number of times that the grass at the entrance of the passage being rolled can be reduced, and a situation that the grass cannot be eliminated by a mowing machine (the autonomous mobile device is a mowing machine) due to indentation is avoided.

In the embodiment, the autonomous mobile device calculates the probability value that it cannot pass through the second passage, so as to select a second passage with a largest probability of passing through among the second passages as the target passage, thereby reducing a number of times that the autonomous mobile device selects the passage.

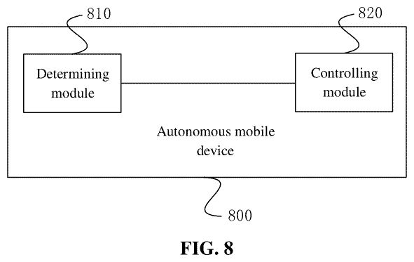

The present disclosure also provides an autonomous mobile device. Referring to FIG. 8, an autonomous mobile device 800 includes:
a determining module 810, configured to determine a first working area where an entrance of a first passage is located when the autonomous mobile device detects that there is an obstacle in the first passage during a process of moving to a charging pile along the first passage;
the determining module 810 is configured to determine a target passage among a plurality of second passages connected with the first working area, where each of the second passages is a passage that the autonomous mobile device has not passed during a pile returning process; and
a controlling module 820, configured to control the autonomous mobile device to travel along the target passage, so that the autonomous mobile device moves to the charging pile.

In an embodiment, the determining module 810 includes:
a first determining unit, configured to determine a pile returning path corresponding to each of the second passages according to a position of the autonomous mobile device, a position of the second passage and a position of the charging pile;
the first determining unit is configured to determine the target passage among the second passages according to each pile returning path.

In an embodiment, the first determining unit includes:
a first determining subunit, configured to determine a second passage corresponding to a pile returning path whose path length is shorter than a preset path length as the target passage.

In an embodiment, the first determining subunit includes:
a determining component, configured to: when pile returning paths whose path lengths are shorter than the preset path length share a same path length, determine a degree of mowing completion of a working area which is passed by the pile returning paths with the same path length;
the determining component is configured to determine a second passage in a pile returning path corresponding to a maximum degree of mowing completion as the target passage.

In an embodiment, the first determining unit includes:
an acquiring subunit, configured to acquire remaining power of the autonomous mobile device;
a second determining subunit, configured to determine, based on a length of the pile returning path and a power consumption per unit length, a total power consumption for returning to the charging pile according to the pile returning path by the autonomous mobile device;
the second determining subunit is configured to determine a second passage included in a pile returning path corresponding to a total power consumption less than the remaining power as the target passage.

In an embodiment, the first determining unit includes:
a second determining subunit, configured to determine a second working area connected with the first working area according to the second passage;
the second determining subunit is configured to determine a position of a third passage in the second working area, wherein the third passage is connected with an area where the charging pile is located and the second working area;
the second determining subunit is configured to determine the pile returning path corresponding to the second passage according to the position of the autonomous mobile device, the position of the second passage, the position of the charging pile and the position of the third passage.

In an embodiment, the determining module 810 includes:
a second determining unit, configured to determine a distance for the autonomous mobile device to travel to each of the second passages;
the second determining unit is configured to determine a second passage corresponding to a minimum distance as the target passage.

In an embodiment, the determining module 810 includes:
an acquiring unit, configured to acquire historical path information about the autonomous mobile device returning to the charging pile;
a third determining unit, configured to determine a first number of times that the autonomous mobile device passes through the second passage and a second number of times that the second passage is impassable according to the historical path information;
the third determining unit is configured to determine a probability value that the second passage is impassable according to the first number of times and the second number of times;
the third determining unit is configured to determine a second passage corresponding to a probability value smaller than a preset threshold as the target passage.

In an embodiment, the third determining unit includes:
a third determining subunit, configured to: when a plurality of probability values smaller than the preset threshold are the same, determine a smallest first number of times among first numbers of times for second passages corresponding to the plurality of probability values; the third determining subunit is configured to determine a second passage corresponding to the smallest first number of times as the target passage.

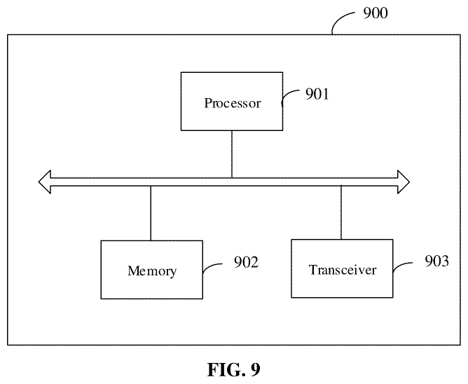

FIG. 9 is a schematic diagram of a hardware structure of an autonomous mobile device shown in an exemplary embodiment.

The autonomous mobile device 900 may include a processor 901, such as a CPU, a memory 902, and a transceiver 903. It can be understood by those skilled in the art that the structure shown in FIG. 9 does not constitute a limitation on the autonomous mobile device, more or less components than those shown in the figure can be included, or some components can be combined, or the autonomous mobile device could have different component arrangements. The memory 902 can be realized by any type of volatile or nonvolatile memory device or their combination, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disc.

The processor 901 can call the computer program stored in the memory 902 to complete all or part of the steps of the above-mentioned method for controlling the autonomous mobile device.

The transceiver 903 is configured to receive information sent by an external device and send information to the external device.

A non-transitory computer readable storage medium, when instructions in the storage medium are executed by a processor of an autonomous mobile device, the autonomous mobile device is enabled to execute the method for controlling the autonomous mobile device as described above.

A computer program product including a computer program, when the computer program is executed by a processor of an autonomous mobile device, the autonomous mobile device is enabled to execute the method for controlling the autonomous mobile device as described above.

A computer program, which, when performed by a processor of an autonomous mobile device, enables the autonomous mobile device to perform the method for controlling the autonomous mobile device as described above.

After considering the specification and practicing the present disclosure disclosed herein, those skilled in the art will easily conceive of other implementations of the present disclosure. The present disclosure is intended to cover any variations, uses or adaptive changes of the present disclosure, the variations, uses or adaptive changes follow the general principles of the present disclosure and include common knowledge or commonly used technical means in this technical field that are not disclosed in the present disclosure. The specification and examples are to be regarded as exemplary only, and a true scope and spirit of the present disclosure are indicated by the following claims.

It should be understood that the present disclosure is not limited to the precise structure described above and shown in the drawings, and various modifications and changes can be made without departing from the scope. The scope of the present disclosure is limited only by the appended claims.

1. A method for controlling an autonomous mobile device, comprising:
determining a first working area where an entrance of a first passage is located when the autonomous mobile device detects that there is an obstacle in the first passage during a process of moving to a charging pile along the first passage;
determining a target passage among a plurality of second passages connected with the first working area, wherein each of the second passages is a passage that the autonomous mobile device has not passed during a pile returning process;
controlling the autonomous mobile device to travel along the target passage so that the autonomous mobile device moves to the charging pile.

2. The method for controlling the autonomous mobile device according to claim 1, wherein the step of determining a target passage among a plurality of second passages connected with the first working area comprises:
determining a pile returning path corresponding to each of the plurality of second passages according to a position of the autonomous mobile device, a position of the second passage and a position of the charging pile to obtain a plurality of pile returning paths respectively corresponding to the plurality of second passages;
determining the target passage among the plurality of second passages according to the plurality of pile returning paths.

3. The method for controlling the autonomous mobile device according to claim 2, wherein the step of determining the target passage among the plurality of second passages according to the plurality of pile returning paths comprises:
determining a second passage corresponding to a pile returning path, whose path length is shorter than a preset path length, of the plurality of second passages as the target passage.

4. The method for controlling the autonomous mobile device according to claim 3, wherein the autonomous mobile device is a mowing robot, and the step of determining a second passage corresponding to a pile returning path, whose path length is shorter than a preset path length, of the plurality of second passages as the target passage comprises:
when two or more pile returning paths, whose path lengths are shorter than the preset path length, of the plurality of pile returning paths share a same path length, determining a degree of mowing completion of a working area which is passed by each of the two or more pile returning paths with the same path length;
determining a second passage in a pile returning path, which corresponds to a maximum degree of mowing completion, of the plurality of second passages as the target passage.

5. The method for controlling the autonomous mobile device according to claim 2, wherein the step of determining the target passage among the plurality of second passages according to the plurality of pile returning paths comprises:
acquiring remaining power of the autonomous mobile device;
for each of the plurality of pile returning paths, determining, based on a length of the pile returning path and a power consumption per unit length, a total power consumption for returning to the charging pile according to the pile returning path by the autonomous mobile device;
determining a second passage comprised in a pile returning path, which corresponds to a total power consumption less than the remaining power, of the plurality of second passages as the target passage.

6. The method for controlling the autonomous mobile device according to claim 2, wherein the step of determining a pile returning path corresponding to each of the plurality of second passages according to a position of the autonomous mobile device, a position of the second passage and a position of the charging pile to obtain a plurality of pile returning paths respectively corresponding to the plurality of second passages comprises:
for each of the plurality of second passages:
determining a second working area connected with the first working area according to the second passage;
determining a position of a third passage in the second working area, wherein the third passage is connected with an area where the charging pile is located and the second working area;
determining the pile returning path corresponding to the second passage according to the position of the autonomous mobile device, the position of the second passage, the position of the charging pile and the position of the third passage.

7. The method for controlling the autonomous mobile device according to claim 1, wherein the step of determining a target passage among a plurality of second passages connected with the first working area comprises:
determining a distance for the autonomous mobile device to travel to each of the plurality of second passages;
determining a second passage, which correspondsing to a minimum distance, of the plurality of second passages as the target passage.

8. The method for controlling the autonomous mobile device according to claim 1, wherein the step of determining a target passage among a plurality of second passages connected with the first working area comprises:
acquiring historical path information about the autonomous mobile device returning to the charging pile;
for each of the plurality of second passages:
determining a first number of times that the autonomous mobile device passes through the second passage and a second number of times that the second passage is impassable by the autonomous mobile device according to the historical path information; and determining a probability value that the second passage is impassable through the second passage according to the first number of times and the second number of times;
determining a second passage, which correspondsing to a probability value smaller than a preset threshold, of the plurality of second passages as the target passage.

9. The method for controlling the autonomous mobile device according to claim 8, wherein the step of determining a second passage, which corresponds to a probability value smaller than a preset threshold, of the plurality of second passages as the target passage comprises:
when a plurality of probability values smaller than the preset threshold are the same, determining a smallest first number of times among first numbers of times for the plurality of second passages corresponding to the plurality of probability values;
determining a second passage, which corresponds to the smallest first number of times, of the plurality of second passages as the target passage.

10. (canceled)

11. An autonomous mobile device, comprising: a memory and a processor, wherein
the memory is configured to store computer executable instructions;
the processor is configured to executes the computer executable instructions stored in the memory to perform operations of:
determining a first working area where an entrance of a first passage is located when the autonomous mobile device detects that there is an obstacle in the first passage during a process of moving to a charging pile along the first passage;
determining a target passage among a plurality of second passages connected with the first working area, wherein each of the second passages is a passage that the autonomous mobile device has not passed during a pile returning process;
controlling the autonomous mobile device to travel along the target passage so that the autonomous mobile device moves to the charging pile.

12. A non-transitory computer readable storage medium having stored thereon computer executable instructions that when executed by a processor of an autonomous mobile device, implement operations of:
determining a first working area where an entrance of a first passage is located when the autonomous mobile device detects that there is an obstacle in the first passage during a process of moving to a charging pile along the first passage;
determining a target passage among a plurality of second passages connected with the first working area, wherein each of the second passages is a passage that the autonomous mobile device has not passed during a pile returning process;
controlling the autonomous mobile device to travel along the target passage so that the autonomous mobile device moves to the charging pile.

13-14. (canceled)

15. The autonomous mobile device according to claim 11, wherein the operation of determining a target passage among a plurality of second passages connected with the first working area comprises:
determining a pile returning path corresponding to each of the plurality of second passages according to a position of the autonomous mobile device, a position of the second passage and a position of the charging pile to obtain a plurality of pile returning paths respectively corresponding to the plurality of second passages;
determining the target passage among the second passages according to the plurality of pile returning paths.

16. The autonomous mobile device according to claim 15, wherein the operation of determining the target passage among the second passages according to the plurality of pile returning paths comprises:
determining a second passage corresponding to a pile returning path, whose path length is shorter than a preset path length, of the plurality of second passages as the target passage.

17. The autonomous mobile device according to claim 16, wherein the autonomous mobile device is a mowing robot, and the operation of determining a second passage corresponding to a pile returning path, whose path length is shorter than a preset path length, of the plurality of second passages as the target passage comprises:
when two or more pile returning paths, whose path lengths are shorter than the preset path length, of the plurality of pile returning paths share a same path length, determining a degree of mowing completion of a working area which is passed by each of the two or more pile returning paths with the same path length;
determining a second passage in a pile returning path, which corresponds to a maximum degree of mowing completion, of the plurality of second passages as the target passage.

18. The autonomous mobile device according to claim 15, wherein the operation of determining the target passage among the second passages according to the plurality of pile returning paths comprises:
acquiring remaining power of the autonomous mobile device;
for each of the plurality of pile returning paths, determining, based on a length of the pile returning path and a power consumption per unit length, a total power consumption for returning to the charging pile according to the pile returning path by the autonomous mobile device;
determining a second passage comprised in a pile returning path, which corresponds to a total power consumption less than the remaining power, of the plurality of second passages as the target passage.

19. The autonomous mobile device according to claim 15, wherein the operation of determining a pile returning path corresponding to each of the plurality of second passages according to a position of the autonomous mobile device, a position of the second passage and a position of the charging pile to obtain a plurality of pile returning paths respectively corresponding to the plurality of second passages comprises:
for each of the plurality of second passages:
determining a second working area connected with the first working area according to the second passage;
determining a position of a third passage in the second working area, wherein the third passage is connected with an area where the charging pile is located and the second working area;
determining the pile returning path corresponding to the second passage according to the position of the autonomous mobile device, the position of the second passage, the position of the charging pile and the position of the third passage.

20. The autonomous mobile device according to claim 11, wherein the operation of determining a target passage among a plurality of second passages connected with the first working area comprises:
determining a distance for the autonomous mobile device to travel to each of the plurality of second passages;
determining a second passage, which corresponds to a minimum distance, of the plurality of second passages as the target passage.

21. The autonomous mobile device according to claim 11, wherein the operation of determining a target passage among a plurality of second passages connected with the first working area comprises:
acquiring historical path information about the autonomous mobile device returning to the charging pile;
for each of the plurality of second passages:
determining a first number of times that the autonomous mobile device passes through the second passage and a second number of times that the second passage is impassable through the second passage according to the historical path information; and determining a probability value that the second passage is impassable through the second passage according to the first number of times and the second number of times;
determining a second passage, which corresponds to a probability value smaller than a preset threshold, of the plurality of second passages as the target passage.

22. The autonomous mobile device according to claim 21, wherein the operation of determining a second passage, which corresponds to a probability value smaller than a preset threshold, of the plurality of second passages as the target passage comprises:
when a plurality of probability values smaller than the preset threshold are the same, determining a smallest first number of times among first numbers of times for the plurality of second passages corresponding to the plurality of probability values;
determining a second passage, which corresponds to the smallest first number of times, of the plurality of second passages as the target passage.

23. The non-transitory computer readable storage medium according to claim 12, wherein the operation of determining a target passage among a plurality of second passages connected with the first working area comprises:
determining a pile returning path corresponding to each of the plurality of second passages according to a position of the autonomous mobile device, a position of the second passage and a position of the charging pile to obtain a plurality of pile returning paths respectively corresponding to the plurality of second passages;
determining the target passage among the second passages according to the plurality of pile returning paths.
